(19) United States
(12) Patent Application Publication
(10) Pub. No.: US 2009/0177677 A1
(43) Pub. Date: Jul. 9, 2009

(54) Navigation device and method

(76) Inventor: Lubos Mikusiak, Nieuw Vennep (NL)

Correspondence Address: TOMTOM INTERNATIONAL B.V., REMBRANDTPLEIN 35, AMSTERDAM, 1017CT, NL

(21) Appl. No.: 12/007,134

(22) Filed: Jan. 7, 2008

(51) Int. Cl. G06F 15/16; G01C 21/20; G06F 17/30

(52) U.S. Cl. 707/101; 709/218; 701/213; 707/100; 707/E17.009

(57) ABSTRACT

A method of updating map data stored in one or more files on a portable navigation device (PND) or navigation system is disclosed. The method includes the steps of establishing a wireless communication with a wireless access point WAP of a wide, local, or wireless local area network having internet connectivity, obtaining an Internet Protocol IP address from the WAP to enable the device or system to become a node on the network and to download content from the internet.

### BACKGROUND OF THE INVENTION

Portable navigation devices (PNDS) including GPS (Global Positioning System) signal reception and processing means are well known and are widely employed as in-car navigation systems. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function provided, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

One particular and more pressing requirement for modern PNDs is the need to update the map information stored in the memory of the device, as such information becomes gradually obsolete. Of course, although major routes within the map information, such as motorways, highways and other arterial roads are unlikely to change much over time, the routes within city centres are being continuously modified, enhanced or restricted to improve traffic flow through a city or to prevent traffic from entering certain zones as the shopping areas become increasingly pedestrianized. Additionally, it would be advantageous to a user to be apprised of long term road repairs which may not be identified in the map information provided with the device on purchase or supply.

U.S. Pat. No. 6,253,151 describes a feature whereby an end user of a navigation system that uses geographic data can easily report perceived errors or inaccuracies in the geographic data or other problems such as poor quality route calculation or guidance. The end user uses a user interface of the navigation system to indicate the perceived error, inaccuracy, or other problem. The navigation system includes a report program that operates in response to the end user's indication. The report program collects information indicating the error, inaccuracy, or other problem and sends a report including the collected information to a geographic database developer. The geographic database developer can use the information in the report to update a geographic database.

The above system however is more concerned with ensuring that a centralized geographical or map database is as current and accurate as possible, as opposed to the ease and simplicity with which such information can subsequently be delivered to a device.

Currently, it is possible for a user to update the map information on his device by physically connecting the device to a PC by means of a USB or other suitable cable, and using a map information, provider-specific, software application which at once recognizes the local connection of a PND, and initiates a handshaking and subsequent download sequence from the servers of the map information provider, or the device manufacturer or supplier. Indeed, applicant here for bundles an application known as “TomTom HOME” with their PNDs for installation on a home PC of the device purchaser, and makes available current map information for download from its servers, for exactly this purpose. The disadvantages with this type of updating procedure are that the user is required to regularly connect the device to the PC to update the map information, which is updated almost daily, or in the case of an vehicle embedded or integrated navigation system, the computer must be connected to the vehicle, as well as to the internet, which can be even more problematical.

Map updates may be distributed on CD or DVD, but this is not a preferred method of map information distribution on account of the cost to the provider. Also, short-term updates, such as road closures are impossible to distribute by this method.

More recent devices are being provided with wireless telecommunications antenna such as Bluetooth™ and GPRS or other mobile telecommunications and signal protocols. However, Bluetooth™ requires user interaction in order for the device to be paired with another suitably enabled device, and the download of data using GPRS and other mobile telecommunications technologies is expensive, particularly for large file downloads, and requires the device to include a subscriber identity module (SIM) card and a corresponding subscription to be paid to the mobile telecommunications service provider before any data can be downloaded over the network.

It is an object of the present invention to provide a PND or navigation system, a method of operating such, and a computer program by means of which such are controlled, which quickly, effortlessly and automatically enables the updating of the map information stored in a PND or navigation system, either incrementally or totally.

### BRIEF SUMMARY OF THE INVENTION

According to the present invention there is provided a method of updating map data stored in one or more files on a navigation device or system, the method including the steps of

Establishing a wireless communication with a wireless access point WAP of a wide, local, or wireless local area network (LAN WAN WLAN) having internet connectivity,
Obtaining an Internet Protocol IP address from the WAP to enable said device or system to become a node on the network and to download content from the internet, and Characterized by the further steps of
Identifying a current version of the map data stored locally on the device or system,
Querying a remote internet-connected device to establish whether map data is available therefrom and the version thereof,
Comparing the version of the local map data with that of the remote map data, and
Downloading the remote map data from said remote internet-connected device after determining that the current version of local map information is less recent than the remote map data version.

In one embodiment, the map data stored on the device or system, or on memory attached to or associated with said device or system, includes base map data optionally augmented with one or more map data updates or to which one or more map data updates have been applied, and the remote map data is provided in the form of one or more map data updates being incremental updates which augment the base map data and said one or more earlier map data updates, or to which the later map data update may be applied.

In an alternative embodiment, the map data stored on the device or system, or on memory attached to or associated with said device or system, consists of a single map data file which is updated by downloading and storing a more recent map data file, and optionally overwriting the earlier map data file. Under normal operation of the device or system, a version check is made of stored map data files, and flag means is set in memory to ensure that the device uses a particular one of the plurality map data files stored.

Preferably the one or more map data update files used to update device- or system-local map data are packaged together, optionally additionally having been previously digitally compressed using any of a number of known compression techniques, in a single executable installation package file.

Preferably, the updating of the map data occurs using an installation routine provided as part of said device or system, said installation routine including a subroutine to cause execution of said executable installation package file subsequent to complete download thereof, such execution causing the said one or more map data update files to be digitally expanded if necessary and installed on the device or system by being stored in a memory thereof, in addition to or in place of pre-existing map data files.

In a preferred embodiment, the method includes the further steps of determining that the device or system is programmed to automatically establish, or attempt to establish a wireless communication at a pre-determined or user-programmed time, such being effected if the device or system time matches or is within or exceeds a predetermined threshold of the pre-determined or pre-programmed time.

In further aspects of the invention, a computer program, embodied on computer readable media as required, is provided for implementing the methods described above, as is a PND and/or navigation system adapted to perform the methods described.

### BRIEF DESCRIPTION OF THE SEVERAL VIEWS OF THE INVENTION

The present application will be described in more detail below by using example embodiments, which will be explained with the aid of the drawings, in which:

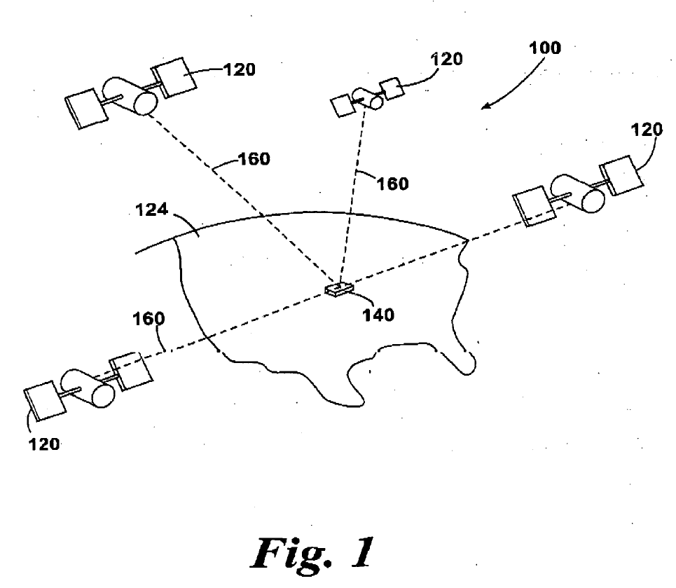

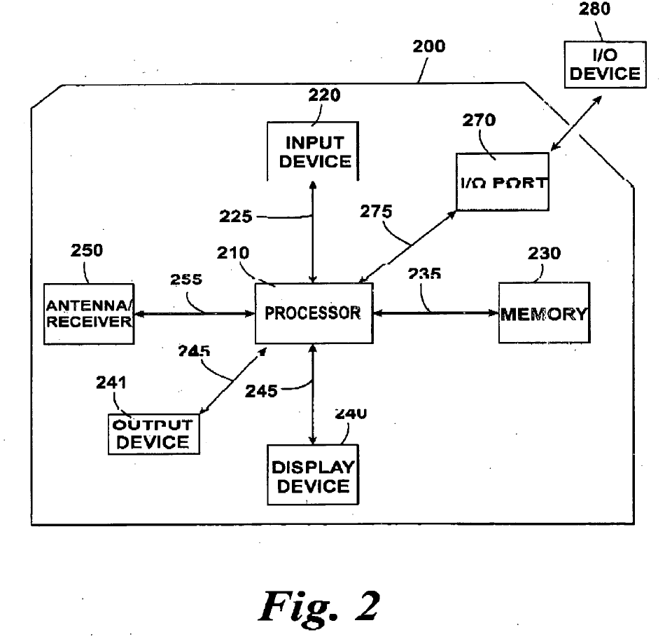

FIG. 1 illustrates an example view of a Global Positioning System (GPS);

FIG. 2 illustrates an example block diagram of electronic components of a navigation device;

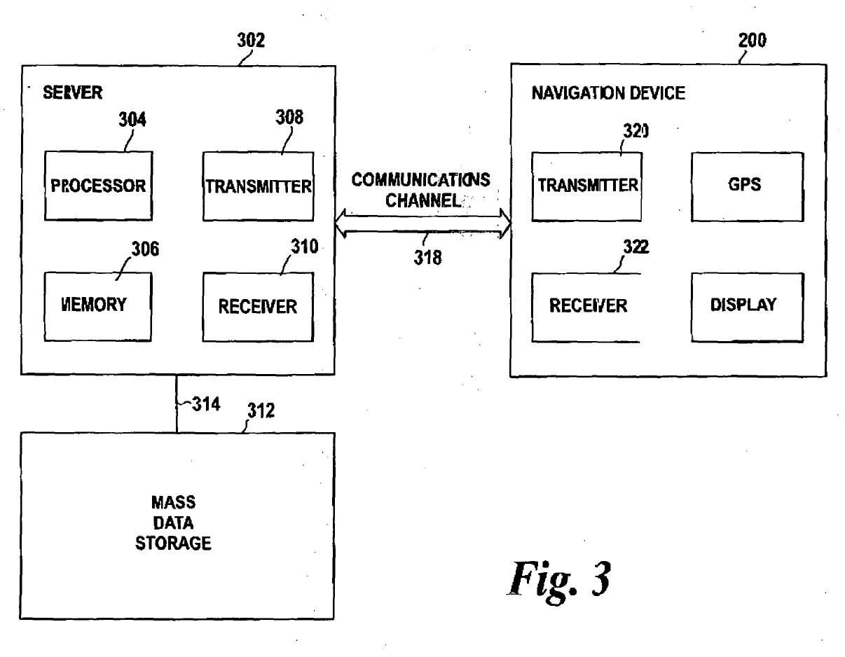

FIG. 3 illustrates an example block diagram of the manner in which a navigation device may receive information over a wireless communication channel;

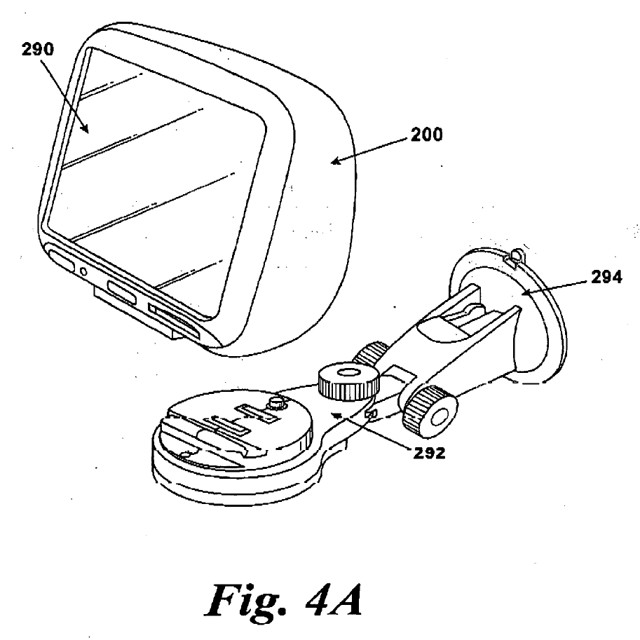

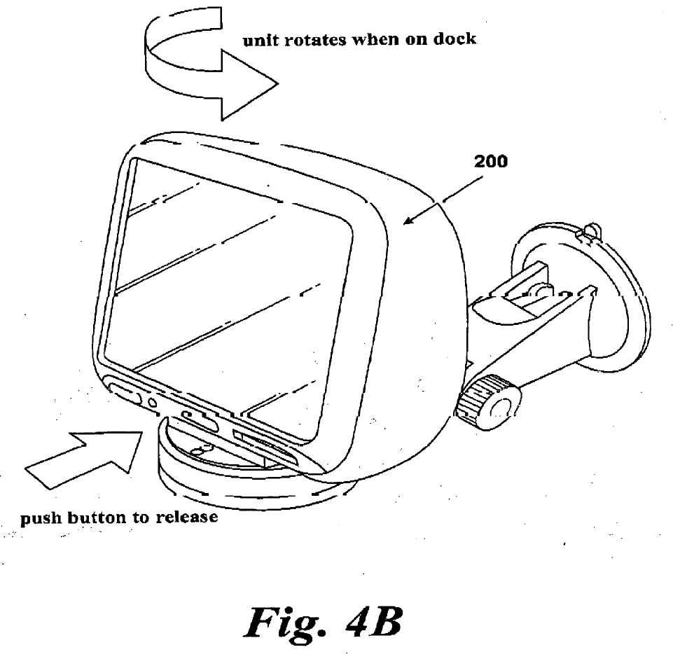

FIGS. 4A and 4B are perspective views of an implementation of an embodiment of the navigation device;

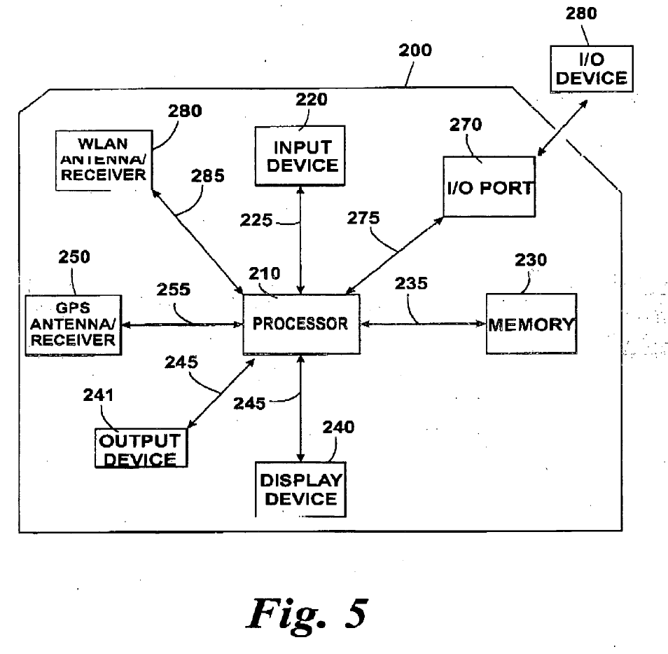

FIG. 5 shows a modified version of a PND including an additional WLAN antenna/receiver, and

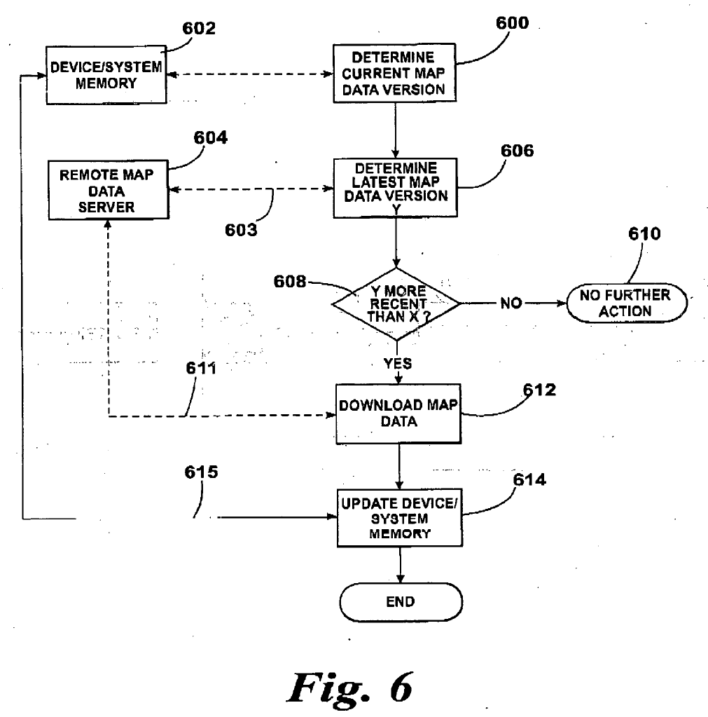

FIG. 6 shows a flowchart representing the operation of the device or system.

### DETAILED DESCRIPTION OF THE INVENTION

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well.

In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked. As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

Referring to FIG. 5, the PND of FIG. 2 is shown enhanced with a WLAN antenna/receiver 280 which communicates with the processor 210 via connection 285. In accordance with the invention, the processor determines a particular version number or other corresponding identifier of the current map data stored in the memory 230 of the device and this is also stored in memory 230. The time at when this determination is made may vary, for example at device start-up, or on first use of the device, in which case the version number may be automatically or otherwise pre-programmed, but in any event, it is possible for the processor to quickly determine the map data version.

The provision of WLAN antenna/receiver 280 enables the device to establish a wireless communication with a corresponding wireless access point WAP (not shown), but of conventional type offering wireless local or wide area networking. Such device may be typically hardwired to a switch, hub, server or other network component, and is capable of negotiating with a suitably enabled wireless device, such as PND 200, so as to establish a communication using a network protocol, such as TCP/IP. As part of this communication, the PND 200 will be assigned a public or more probably private IP network address, whereupon the PND effectively becomes part of the public/private network and becomes a node thereon. Once this is achieved, the device can communicate with, and request data from other similarly connected network nodes. In the case that the device is assigned a private network address, such as 192.168.x.x or 10.x.x.x, it is usual for the host or a remote device or native or remote software application to provide a monitored and optionally proxied connection to the public internet to allow for the transfer of information thereto and therefrom, as is known for conventional PCs.

In a preferred embodiment, the establishment of a data communication between the device and the WAP is initiated automatically by software operating on the device. For example, the majority of users of PNDs (and integrated in-car navigation systems, to which this invention may apply), may return to their place of residence after their travels during the day. It is thus more likely that during the evening or night, the device or system is inoperative and within the home or within the home owner's car parked proximate the home, and therefore an update of the map data stored on the device or system can be effected without inconvenience to or indeed any input from, the user.

It is increasingly popular for home owners to provide WLAN equipment in their homes, for example wireless broadband or asymmetric digital subscriber line (ADSL) routers, to provide their entire premises with wireless internet access capability for any device, typically laptop and personal computers having wireless networking cards therein. In accordance with the invention, it is desired to enhance existing PNDs and navigation systems with a wireless networking device, typically a WLAN antenna/receiver and associated signal processing electronics so that the device or system can also connect to the home wireless network, and thus to the internet.

Thus, in possible alternative configurations, either the user makes a selection of a suitable programmed option within the device to initiate a wireless communication, or operating software within the device automatically causes the device to attempt to establish such a communication with a WAP and obtain an IP address therefrom. Once this is achieved, the software of the device makes a request of a remote known web or data server for version information of the map data stored on that server, or on a different server but one to which said remote web or data server has access. The device then compares the received version information with that stored locally for the current map data files in use on the device, and on determining that the remotely stored map data is more recent, a request is sent to the remote web or data server to commence download of one or more map data files containing either the entire map data files for one or more countries or specified regions, or incremental updates for such which can then be applied to the local map data stored in memory on the device.

As will be appreciated, in the case that the map data downloaded is complete in that it represents the total map information content for a particular area, region or country, the download may take a significant period of time, even taking into account the enhanced data transfer rates of the most modern broadband internet connections. For example, base map data files for Western Europe can be approximately 530 MB, and the interface files, being those files which act as the interface between the operating system software of the device or system and the base map content and enable the extraction of useful information therefrom, may be in the region of 250 MB. As can be appreciated, an incremental update routine is preferred but not essential.

In a preferred mode of operation of a device or system which has already established a communication with a WAP and is part of an internet-connected network, and with reference to FIG. 6, it is desired that the device firstly determines the current map data version, as indicated at 600, from the device memory 602 in which the map data is stored and which thus includes map data version information. The indicator of map data version information is indicated as X in the flowchart of FIG. 6.

In a second step, the device makes a request 603 of a remote map data server 604 for map data version information, and retrieves such information Y at 606. Thereafter a comparison is effected at 608 to determine whether the remote map data is more recent than that already within the device, and if the locally stored map data is up to date, the routine ends at 610. However, in the event that the remote map data version is more recent than that stored in the device, then a download procedure 611 is initiated at 612, such receiving one or more files, at least one of which contains base map data, from the server 604. On complete download of the one or more files, or possibly during download thereof, an update/installation routine commences at 614 whereby the one or more map data files and any associated interface files are installed in the device memory 602, as indicated at 615. Once installed, the map data files are ready for use, with the possible optional requirement for a device re-boot or re-start. In a preferred embodiment, particularly when device resources are limited, the pre-existing outdated map data files are overwritten, but it is possible that such are retained, particularly in the case where an incremental update procedure is required.

In a yet further embodiment, the download of map data may be made by means of the download of a number of separate, different and unpackaged data files. While it is possible to download a single map data file for an entire country-wide area or region, this is onerous, both in terms of time-to-download and bandwidth, and additionally, in the case where map data files are stored on a removable media device such as a secure digital SD™ card or microSD™ card, the overwriting of a pre-existing large map data file with a more recent file is time consuming, and can require a significant amount of free space on the media before successful overwriting can occur. One possible solution to this problem is to divide the map data files into smaller patch files which may be downloaded separately or in small batches, and then immediately (and more quickly) applied to the base map data files stored in the device or system, or such files having been already updated by the application of earlier patches as the case may be.

The subdivision of map data files into smaller map patch files allows for enhanced downloading and updating strategies. For example, one enhanced updating strategy may be to download map patch files sequentially based on geo-spatial proximity to the current position or the last known or other previously recorded positions of device or system. Using such a strategy, the map patch files applicable to portions of the base map data closest to that position would be downloaded first and appropriately applied, whereas those map patch files applicable to map data files or portions thereof containing map information for more remote areas or regions would be downloaded and applied thereafter.

A further option, implementable in software on the device or system, would be to offer the user an option for spatial filtering of remote map patch files in order to minimize download times, patch application times and also traffic between the device or system and the server. For example, spatial filters such as “within a radius of x km around the currently stored ‘home’ location”, “within a radius of x km around the currently or most recently recorded location”, “an [user-defined] area [such as a polygon or rectangle] covering recorded routes/locations visited during the last x days”, or “an area which is a buffer zone around a planned route or set of routes stored in memory”.

Other download, updating and filtering strategies are conceivable.

In an alternative aspect of the invention, where the device or system is provided with USB connectivity in the form of a USB port, it may be possible to connect the device physically via a USB cable directly to a router or other network appliance capable of negotiating and assigning an IP address to the device or system. In this case, only software, as opposed to any specific hardware dedicated to establishing a wireless communication with a WAP, is required on the device, as the protocol stack is capable of being handled by the more standard components within the device, e.g. processor, memory and the like. This scenario is to be distinguished from the more conventional scenario of connecting a PND to a PC by means of a USB cable, as in the latter scenario, only the PC is a node on the internet-connected network, and the PND is merely a peripheral to the PC.

Most preferably, the software of the & vice or system includes a download routine which is initiated automatically when it is determined that a physical USB connection has been made between the PND or system and a network appliance, and an IP address has been assigned to said device or system. Alternatively, the download routine is configured to start at a predetermined, user-selectable time after a physical USB connection has been made and the device or system has been assigned an IP address.

1. A method of updating map data stored in one or more files on a navigation device or system, the method including the steps of:
Establishing a wireless communication with a wireless access point WAP of a wide, local, or wireless local area network having internet connectivity,
Obtaining an Internet Protocol IP address from the WAP to enable said device or system to become a node on said network and to download content from the Internet,
Identifying a current version of said map data stored locally on said device or system,
Querying a remote, internet-connected device to establish whether mal data is available therefrom and a version thereof,
Comparing said version with that of said remote map data, and
Downloading remote map data from said remote internet-connected device after determining that said current version of local map information is less recent than said remote map data version.

2. The method according to claim 1, wherein said downloaded map data is provided in a form of one or more map data updates being incremental updates which augment a base map data file optionally already having had one or more earlier map data updates applied thereto.

3. The method according to claim 2, further comprising the step of determining, from a memory of said device or system, whether one or more download criteria has been set, said download of remote map data occurring in compliance with said download criteria if set.

4. The method according to claim 3, wherein a criterion makes a download of map data files dependent on one or more locations also stored in said memory, remote map data files including map update information for specific locations or regions coincident with, proximate to, or including said stored locations being downloaded preferentially as compared to other remote map data update files of less relevance to said stored location or locations.

5. The method according to claim 3, wherein a criterion makes a download of map data files dependent on one or more area identifiers stored in memory, remote map data files including map update information for specific locations or regions coincident with, proximate to, or including said area identification being downloaded preferentially as compared to other remote map data update files of less relevance to said stored area identifiers.

6. The method according to claim 3, wherein a criterion makes a download of map data files dependent on one or more established route identifiers stored in memory, remote map data files containing map update information for specific locations or regions coincident with, proximate to, or including said established route identifiers being downloaded preferentially as compared to other remote map data update files of less relevance to said stored established route identifiers.

7. The method according to claim 1, wherein said map data stored on said device or system comprises a single map data file which is updated by downloading and storing a more recent map data file.

8. The method according to claim 1, further comprising the step of overwriting earlier map data file or files stored on said device or system.

9. The method according to claim 1, wherein said one or more map data update files used to update existing map data files are digitally packaged in a single installable executable file.

10. The method according to claim 9, further comprising the step of compressing said one or more digitally packaged map data files a single installable executable file, execution of which within the device causes both decompression of the one or more files together with their installation.

11. The method according to claim 1, further comprising the steps of determining that said device or system is programmed to automatically attempt to establish a wireless communication at a pre-determined or user-programmed time, such being effected if said device or system time matches or is within or exceeds a predetermined threshold of a predetermined or pre-programmed time.

12. (canceled)

13. (canceled)

14. A navigation system including at least a processor, memory, a graphical display, and a GPS signal antenna, capable of receiving a plurality of GPS signals from a plurality of GPS satellites, said memory having stored therein one or more files in which map data is stored and which is displayed on the screen of the system as it performs a navigation function, said one or more files additionally having version information associated therewith, said navigation system further comprising:
a second wireless signal transmission and reception means by virtue of which a communication with a proximate wireless access point WAP can be established using an internet protocol such that said system effectively becomes a node on an internet-connected network and is provided with an IP address, and
a programming arranged such that once a wireless connection has been established, said programming is executed to cause said system to make a request of a remote node on said internet-connected network to determine version information of map data stored thereat or available there from, to compare remote map data version information with map data version information of locally stored map data, and to initiate subsequent download of one or more remote map data files, and installation thereof in said memory, in an event that said version information comparison indicates that one or more
